(19) United States
(12) Patent Application Publication
(10) Pub. No.: US 2026/0015874 A1
(43) Pub. Date: Jan. 15, 2026

(54) INTERCHANGEABLE ASSEMBLY FOR TOOL HEADS

(71) Applicant: JoseLuis Jimenez Ponce, Gustine, CA (US)

(72) Inventor: JoseLuis Jimenez Ponce, Gustine, CA (US)

(21) Appl. No.: 19/268,536

(22) Filed: Jul. 14, 2025

Related U.S. Application Data
(60) Provisional application No. 63/671,430, filed on Jul. 15, 2024.

(51) Int. Cl. E04F 21/24; B25G 3/00

(52) U.S. Cl. CPC E04F 21/24; B25G 3/00

(57) ABSTRACT

An assembly for interchangeably and removably mounting tool heads wherein the tool heads are for concrete works. The assembly includes a plate having a top face and a bottom face; a frame is coupled to the top face; a handle is mounted to the frame; and magnets are coupled to the bottom face of the plate. A tool head can be removably and interchangeably mounted to the one or more magnets. The assembly with the tool head works similarly to a tool for concrete work.

### CROSS REFERENCE TO RELATED APPLICATIONS

This application claims priority from a U.S. Provisional Patent Appl. No. 63/671,430, filed on Jul. 15, 2024, which is incorporated herein by reference in its entirety.

### FIELD OF INVENTION

The present invention relates to an interchangeable assembly for tool heads and implements, and more particularly, the present invention relates to a magnet-based assembly for interchangeably mounting tool heads.

### BACKGROUND

Finishing concrete requires precision and the right tools. These tools are usually cumbersome and heavy. Carrying multiple cumbersome tools is often laborious and tiresome. Also, the purchasing and maintenance costs for multiple tools are high. Often, the user is reluctant to carry a large number of tools and ends up using the same tool for multiple purposes, resulting in a loss of quality of work and efficiency.

A need is therefore appreciated for an assembly that overcomes the problems with conventional tools.

The terms “tool” and “implement” are used interchangeably herein and refer to any tool or implement used in concrete works and brick works.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to an assembly to which different tool heads can be removably and interchangeably mounted.

Another object of the present invention is that the need for carrying multiple tools is avoided, but only tool heads can be carried.

Still another object of the present invention is that the cost of buying and maintaining multiple tools can be significantly reduced.

A further object of the present invention is that the assembly is quick and easy to use.

Still, a further object of the present invention is that multiple types of tool heads can be interchangeably used.

In one aspect, disclosed is an assembly for interchangeably and removably mounting tool heads, the assembly comprising a plate having a top face and a bottom face; a frame coupled to the top face; a handle mounted to the frame; and one or more magnets coupled to the bottom face of the plate, wherein the one or more magnets are configured to removably and interchangeably mount tool heads. The one or more magnets are bar magnets. The one or more magnets are coupled to the plate using fasteners. The one or more magnets comprise three magnets placed spaced apart from each other.

In one aspect, disclosed is a tool for concrete work, the tool comprising a plate having a top face and a bottom face; a frame coupled to the top face; a handle mounted to the frame; one or more magnets coupled to the bottom face of the plate; and a tool head removably and interchangeably mounted to the one or more magnets. The one or more magnets are bar magnets. The one or more magnets are coupled to the plate using fasteners. The one or more magnets comprise three magnets placed spaced apart from each other.

In one aspect, disclosed is a method for concrete works, the method includes providing an assembly comprising a plate having a top face and a bottom face; a frame coupled to the top face; a handle mounted to the frame; and one or more magnets coupled to the bottom face of the plate. The method further includes coupling, removably and interchangeably, a first tool head to the one or more magnets; removing the first tool head; and coupling, removably and interchangeably, a second tool head to the one or more magnets.

### BRIEF DESCRIPTION OF DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 shows a perspective view of the assembly, according to an exemplary embodiment of the present invention.

FIG. 2 shows the assembly with a tool head, according to an exemplary embodiment of the present invention.

FIG. 3 shows the assembly with another tool head, according to an exemplary embodiment of the present invention.

FIG. 4 shows the assembly with another tool head, according to an exemplary embodiment of the present invention.

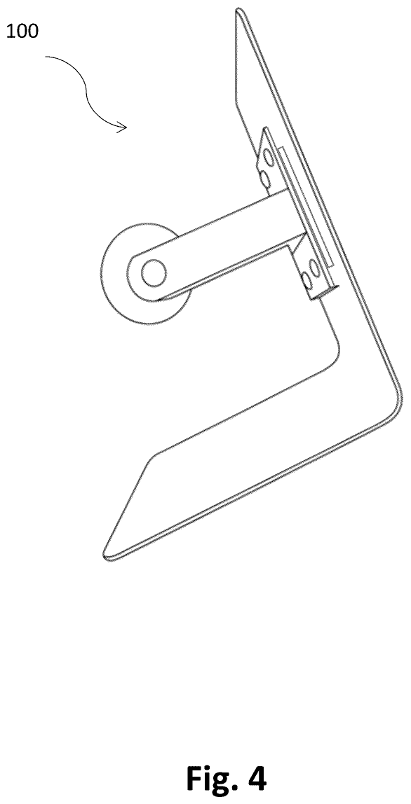

FIG. 5 shows the assembly with another tool head, according to an exemplary embodiment of the present invention.

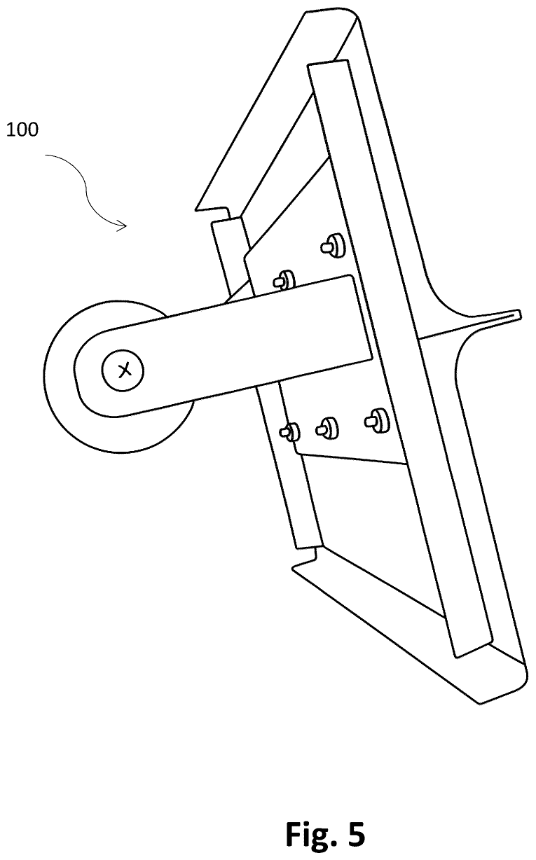

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

The described invention pertains to an assembly that can interchangeably mount different tool heads. The tool heads can be working parts of tools used in concrete work. The tool head can be removably and interchangeably mounted to the assembly. The assembly with the tool head may work similarly to the respective tool. Thus, a user can now carry the disclosed assembly and different tool heads. The tool heads are not bulky and cumbersome like their complete tool sets. This significantly reduces the labor and hardship for the user in carrying the different tool sets. Also, the user can now merely buy the tool heads, thus resulting in significant savings.

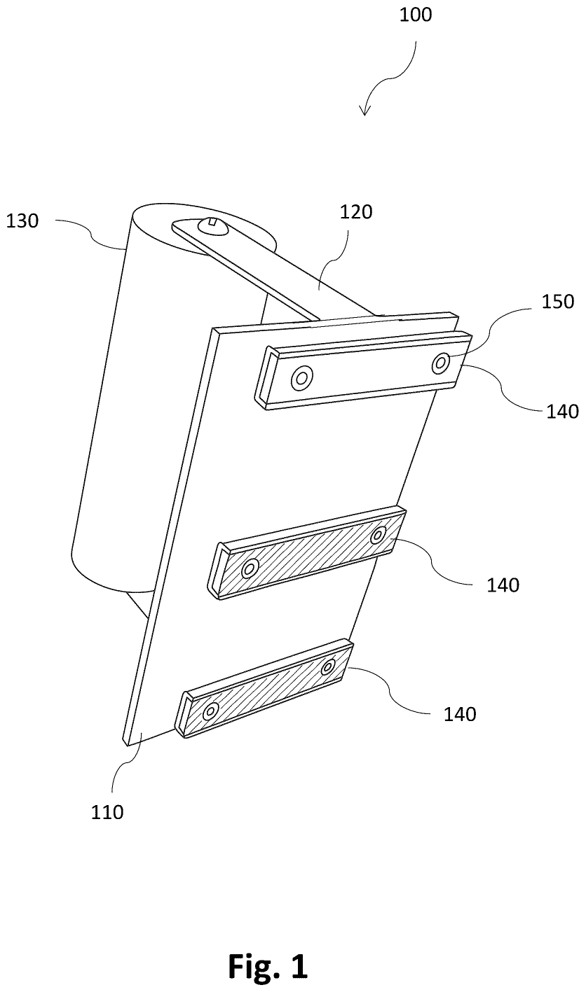

Referring to FIG. 1, which shows a perspective view of the assembly 100. The assembly includes a plate 110. The plate 110 may be of a planar profile, wherein the shape and size of the plate may be varied without departing from the scope of the present invention. The drawings show the plate in a rectangular shape. The plate may be made from any rigid, durable, and strong material, such as metal. The plate may have a top face and a bottom face.

The assembly may further include a frame 120 coupled to the top face of the plate. The frame includes a bottom wall, a left wall, and a right wall, wherein the left wall, the bottom wall, and the right wall are continuous. The left wall and the right wall extend perpendicular from the bottom wall. The bottom wall is aligned with the plate 110 and is coupled to the plate 110 using suitable fastening mechanism, such as welding, screws, and the like. The left wall and the right wall are opposite to each other and run parallel. It is to be noted that the frame may be integral with the plate.

The assembly further includes an elongated handle 130 mounted to the ends of the left wall and the right wall of the frame. The handle shown in the drawing is cylindrical. It is to be noted that the shape and size of the handle may be varied without departing from the scope of the present invention. The shape of the handle may preferably be ergonomic, which allows the tool head mounted to the assembly to be effectively maneuvered for concrete work. The handle can be made from any suitable material, such as wood, plastic, or metal. The wood and plastic are soft on the hands and may be preferable.

The assembly further includes one or more magnets 140 coupled to the bottom face of the plate 110. The magnets 140 can be coupled using suitable fasteners 150, such as nuts and bolts. Preferably, the magnets may be bar-shaped magnets. Two or more magnets may be incorporated. FIG. 1 shows three bar magnets coupled, spaced apart from each other, on the bottom face of the plate with nuts and bolts. The magnets may be strong enough to hold the tool head while using the tool head for concrete work. For magnetic strength, multiple magnets can be used.

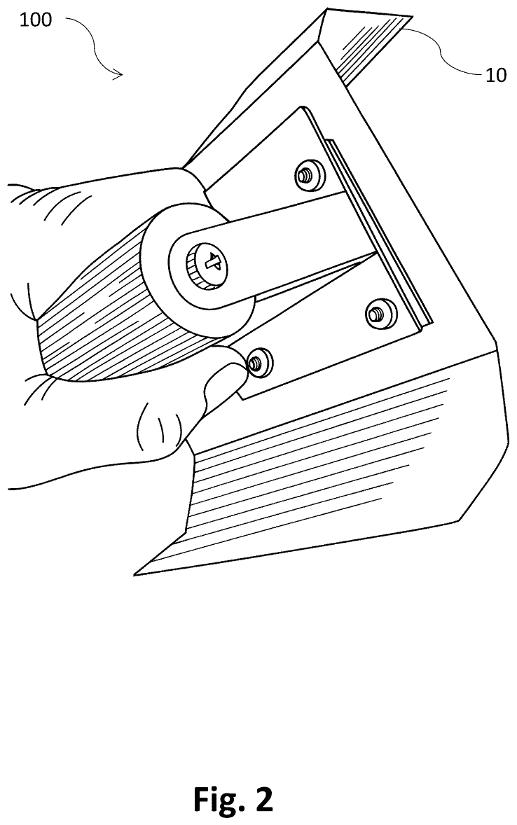

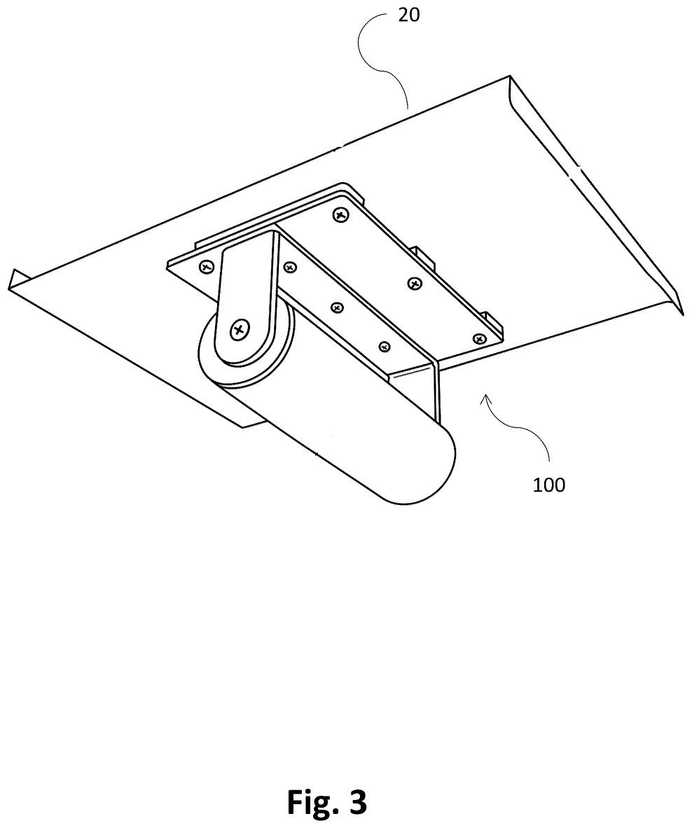

Referring to FIGS. 2 and 3, which show different tools 10 and 20, interchangeably coupled to the assembly using magnetic forces of the magnets. It is obvious that at least some part of the tool head may be made from material, such as iron, that can be magnetically coupled to the magnets.

In use, the surface of magnets can be checked for any contamination. The surface of magnets can be cleaned if required. Similarly, the surface of the tool head, at least coming into contact with the magnets, can be cleaned. This may ensure stronger magnetic bonds between the tool head and the assembly; however, the step of cleaning is optional. After cleaning, the tool head can be attached to the assembly through magnets, and the assembly with the tool head can be used. The assembly with the tool head can be used similarly to the respective tool set, i.e., the tool head with the handle and body. Once used, the tool head can be removed, and another tool head can be attached.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. An assembly for interchangeably and removably mounting tool heads, the assembly comprising:
a plate having a top face and a bottom face;
a frame coupled to the top face;
a handle mounted to the frame; and
one or more magnets coupled to the bottom face of the plate, wherein the one or more magnets are configured to removably and interchangeably mount tool heads.

2. The assembly of claim 1, wherein the one or more magnets are bar magnets.

3. The assembly of claim 1, wherein the one or more magnets are coupled to the plate using fasteners.

4. The assembly of claim 1, wherein the one or more magnets comprises three magnets placed spaced apart from each other.

5. A tool for concrete work, the tool comprising:
a plate having a top face and a bottom face;
a frame coupled to the top face;
a handle mounted to the frame;
one or more magnets coupled to the bottom face of the plate; and
a tool head removably and interchangeably mounted to the one or more magnets.

6. The tool of claim 5, wherein the one or more magnets are bar magnets.

7. The tool of claim 5, wherein the one or more magnets are coupled to the plate using fasteners.

8. The tool of claim 5, wherein the one or more magnets comprise three magnets placed spaced apart from each other.

9. A method for concrete works, the method comprising:
providing an assembly comprising:
a plate having a top face and a bottom face;
a frame coupled to the top face;
a handle mounted to the frame; and
one or more magnets coupled to the bottom face of the plate;
coupling, removably and interchangeably, a first tool head to the one or more magnets;
removing the first tool head; and
coupling, removably and interchangeably, a second tool head to the one or more magnets.

10. The method of claim 9, wherein the one or more magnets are bar magnets.

11. The method of claim 9, wherein the one or more magnets are coupled to the plate using fasteners.

12. The method of claim 9, wherein the one or more magnets comprises three magnets placed spaced apart from each other.
